(19) United States
(12) Patent Application Publication
(10) Pub. No.: US 2018/0162987 A1
(43) Pub. Date: Jun. 14, 2018

(54) DEGRADABLE POLYURETHANES AND COMPOSITES THEREOF

(71) Applicant: Adesso Advanced Materials Wuhu Co., Ltd., Wuhu, Anhui (CN)

(72) Inventors: Bo Liang, Plainsboro, NJ (US); Xin Li, Cambridgeshire (GB); Bing Qin, Shanghai (CN)

(73) Assignee: Adesso Advanced Materials Wuhu Co., Ltd., Wuhu, Anhui (CN)

(21) Appl. No.: 15/571,091

(22) PCT Filed: May 3, 2016
(86) PCT No.: PCT/CN2016/080870

§ 371 Date: Nov. 1, 2017

Related U.S. Application Data
(60) Provisional application No. 62/156,328, filed on May 3, 2015.
(60) Provisional application No. 62/156,278, filed on May 3, 2015.

(51) Int. Cl. C08G 18/76; C08G 18/32; C08G 18/42; C08K 7/06; C08J 11/16

(52) U.S. Cl. CPC C08G 18/7671; C08G 18/7621; C08G 18/3225; C08G 18/42; C08J 11/16; C08G 18/3246; C08G 18/3243; C08K 7/06; C08G 18/3228

(57) ABSTRACT

Among others, the present invention provides isocyanate resin compositions which include an isocyanate compound containing two or more isocyanate functional groups; a chain extender comprising a degradable diamine and optionally a dihydric alcohol, a polyether diol, a polyester diol, a diamine, a dimercaptan, or a bisphenol; and a cross-linker comprising a degradable polyamine and optionally a trifunctional, tetrafunctional or polyfunctional polyhydric alcohol, polyether polyol, polyester polyol, polyamine, polymercaptan, or polyphenol.

### CROSS-REFERENCE TO RELATED APPLICATIONS

This application claims priority to U.S. Application Nos. 62/156,328 and 62/156,278, both filed on May 3, 2015, the contents of which are incorporated herein by reference in their entireties.

### BACKGROUND OF THE INVENTION

Polyurethane backbone contains a high molecular polymeric chain with a repeating segment of urethane. This synthetic material has wide-range applications. Up to now, the polyurethane that has been widely used as a biomedical polymer material is obtained through the process under which the prepolymer of the isocyanate terminated matrix, synthesized by the macromolecule dihydric alcohol and the excess of diisocyanate, can combine with low molecular diol or diamine to undergo the chain reaction. Thereinto, the macromolecule polyhydric alcohols become the flexible chain; di-isocyanate and chain-extender turn into the rigid chain. Take the frequently-used di-isocyanate and dihydric alcohol as the examples and the reaction scheme is as follows:

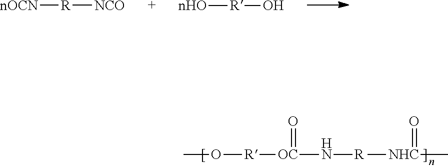

The flexible chain of polyurethane is generally constituted by the polyether or polyester with weak polarity, which reflects its elastic properties. The glass transition temperature, tensile strength, elongation, abrasion resistance, shear strength, blood compatibility and the hydrophilic properties of polyurethane can be regulated by the molecular design and choose different types of flexible chain or different molecular weights of rigid chain, or combine several kinds of flexible chain and rigid chain into the application to make the polyurethane possess the specific properties. The polymerization could generate the block or cross-linked polymer. More than the carbamate included in the polyurethane macromolecule, the ether, ester, urea, biuret, allophanate matrix etc. could be also contained. The structures of polyurethane macromolecule are changeful, whose properties could be adjusted over a wide range. Different numbers and different types of functional groups take different synthesis crafts to prepare the polyurethane products with different varieties and properties.

Under the natural conditions, the vast majority of plastics and other macromolecule materials currently used are non-degradable and the heavy use of macromolecule materials could cause serious problems of white pollution, and then the environment was destroyed enormously. With the gradually deteriorating environmental problems of global warming, pollution has arisen in the earth, environmental protection is urgently required. Now, many countries have made the legislation to restrict the use of non-degradable single-used plastic bags and promote the use of disposable shopping bags, garbage bags made by biodegradable plastic. In the packaging industry and elsewhere, polyurethane foam plastics, which possess excellent high specific strength, good insulation properties, fine vibration cushioning properties and other characteristics, can be used as the high-grade packaging materials. Polyurethane material with good biocompatibility anti-thrombotic property has the advantages of excellent mechanical properties, easy processing, low price, etc. So it has a broad application prospects in the biomedical field. But these hardly degradable polyurethane plastics have brought the environmental pollution problems for the industrial development. Therefore, the degradation property of polyurethane material has a crucial importance in the application of packaging and biomedical industries.

Currently, the polyurethane recycling methods contain the physical recycling, incineration recycling and chemical recycling. The physical recycling methods do not destroy the chemical structure of the polymer and do not change its composition. The polyurethane could be reused, much undervalued, as the filler, molding compound and other purposes. The physical recycling method of polyurethane is simple to execute. However, the market of the products obtained by this method is limited and the technical limitations of process also have arisen. The recycling waste is mainly the low-grade scrap recycling polyurethane waste. The incineration recycling method mainly takes the incineration method to obtain energy from the polyurethane waste, whilst a large amount of toxic fume and residue would be discharged to cause serious environmental pollution as the incomplete combustion of polyurethane happens in the incineration process. As to the chemical recycling method, its purpose is to degrade the polyurethane into the reused liquid oligomer or the organic compound with small molecule under the condition of the chemical reagents and catalysts applied in the polyurethane. The recycling of raw material would be achieved by above-mentioned chemical method. However, due to its limitations of price and prohibitive cost, the technology for chemically recycling polyurethane is still very immature with the low practical use and commercialization rate. As such, solutions are urgently needed to protect the environment from solution caused by the polyurethane waste that cannot be recycled due to the current technological limits.

### SUMMARY OF THE INVENTION

Aiming at the problems of the existing technology, this invention provides novel recyclable polyurethanes and the preparation methods of making such recyclable polyurethanes either through degradable isocyanates reaction with diol or polyols, and degradable diamines or polyamines or through standard di- or poly-isocyanates reaction with diols, polyols, and degradable diamines or polyamines. The recyclable polyurethane polymers provided by this invention have good mechanical property, and are expected to be widely used where fiber-reinforced composites are currently used. Under the specific conditions, the composite could be degraded and valuable materials can be recycled and reused. The reinforced material and polymer matrix can be separated and recycled. Moreover, the degradation recovery method of composite could be easily and economically controlled under mild reaction conditions.

In one aspect, the present invention provides isocyanate resin compositions each including:

an isocyanate compound containing two or more isocyanate functional groups; and

a chain extender comprising a degradable diamine and optionally a dihydric alcohol, a polyether diol, a polyester diol, a diamine, a dimercaptan, or a bisphenol; wherein the degradable diamine is of the structure of

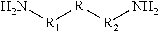

in which R is

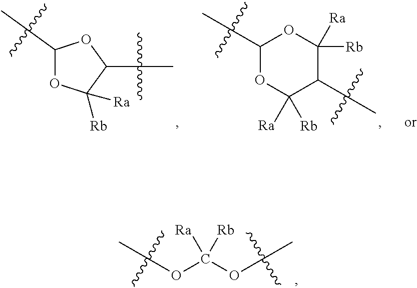

each of Ra and Rb is independently hydrogen, alkylene, cycloalkylene, heterocyclic alkylene, arylene and heteroarylene; or Ra and Rb, together with the carbon atom to which they are bonded, form a 3-7 membered ring optionally containing 1-5 heteroatoms each of which is independently S, O, or N; and each of R₁ and R₂ is independently alkylene, cycloalkylene, heterocyclic alkylene, arylene, heteroarylene, or aralkylene; and

a cross-linker comprising a degradable polyamine and optionally a trifunctional, tetrafunctional or polyfunctional polyhydric alcohol, polyether polyol, polyester polyol, polyamine, polymercaptan, or polyphenol; and the degradable polyamine is of Formula 1,

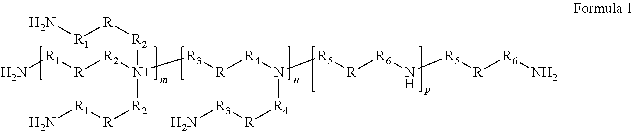

wherein each of m, n, and P, independently, is an integer of 0, 1, 2, 3, 4, 5, 6, 7, 8, 9, or 10; the sum of m, n and p is 3 or greater; R, R₁, and R₂ are the same as defined above for the degradable diamine in the chain extender; each of R₃, R₄, R₅ and R₆, independently, is alkylene, cycloalkylene, heterocyclic alkylene, arylene, heteroarylene, or aralkylene.

In some embodiments, the isocyanate compound includes m-phenylene diisocyanate, 1,4-phenylene diisocyanate, 2,4-toluene diisocyanate, 2,6-toluene diisocyanate, 1,6-hexamethylene diisocyanate, isophorone diisocyanate, tetramethylxylene diisocyanate, tetramethylene diisocyanate, cyclohexane 1,4-diisocyanate, hexahydrotoluene diisocyanate, 1,5-naphthalene diisocyanate, 1-methoxyphenyl-2,4-diisocyanate, 2,2′-diphenylmethane diisocyanate, 2,4′-diphenylmethane diisocyanate, 4,4′-diphenylmethane diisocyanate, 1-methoxyphenyl-2,4-diisocyanate, 4,4′-biphenylene diisocyanate, 3,3′-dimethoxy-4,4′-diisocyanate, 3,3′-dimethyldiphenylmethane-4,4′-diisocyanate, 4,4′,4″-triphenylmethane triisocyanate, toluene 2,4,6-triisocyanate, 4,4′-dimethyldiphenylmethane 2,2′-5,5′-tetraisocyanate, polymethylene polyphenylene polyisocyanate, or an isomer thereof.

In some other embodiments, the degradable diamine in the chain extender includes or is selected from:

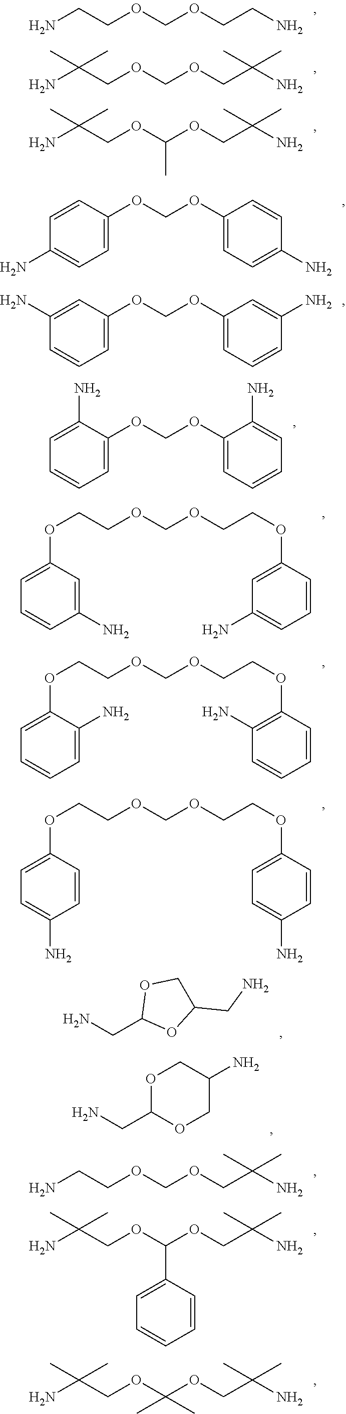

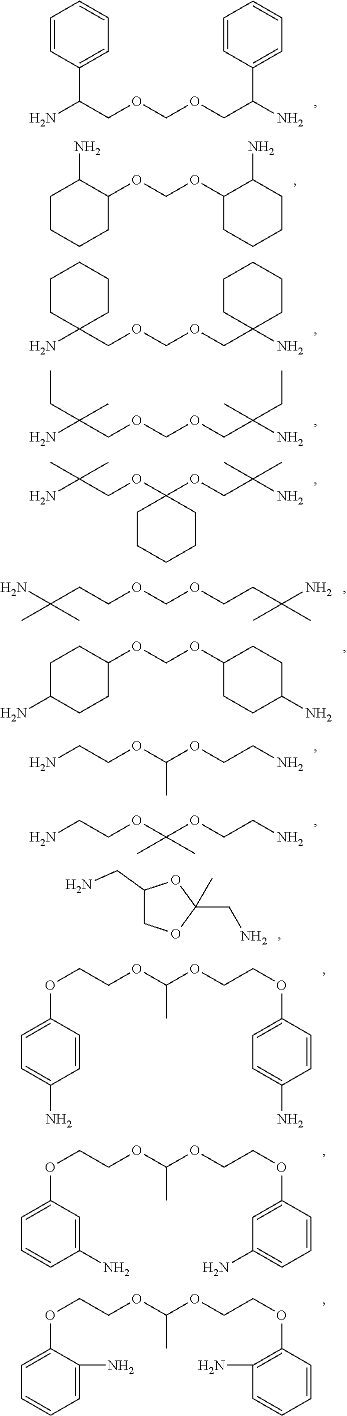

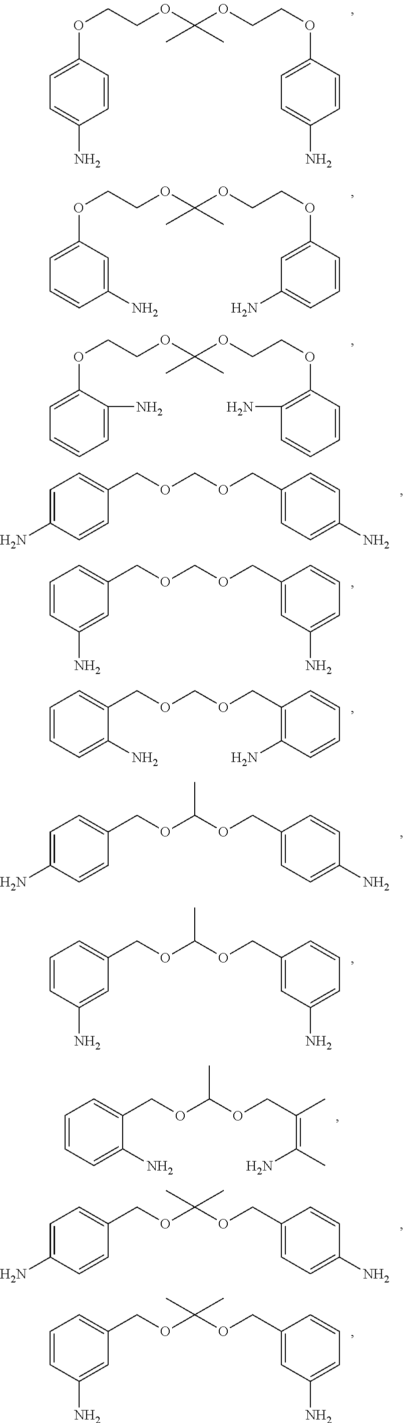

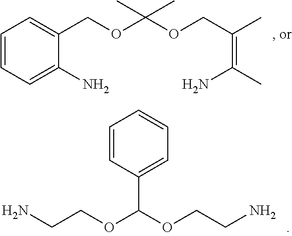 [SMILES: C/C(N)=C(\C)COC(C)(C)OCc1ccccc1N ; NCCOC(OCCN)c1ccccc1]

In still some other embodiments, the degradable polyamine in the cross-linker includes:

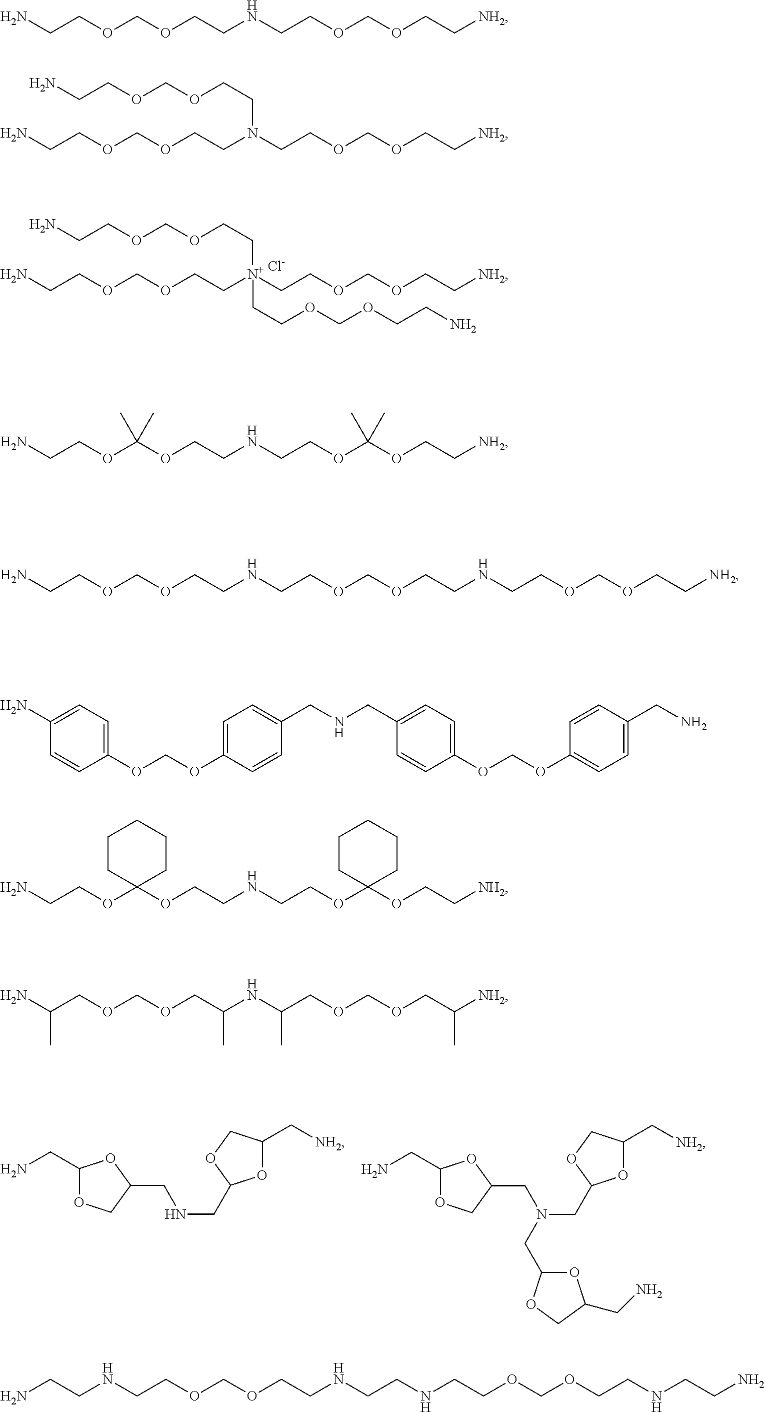

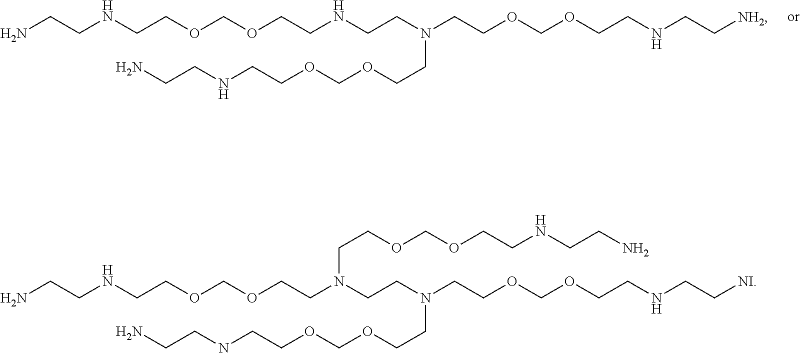

In another aspect, the present invention provides degradable three-dimensional reticulated polyurethane matrices, wherein each polyurethane matrix is obtained by curing an isocyanate resin composition described above and possesses cross-linking points that are derived from reacting the cross-linker comprising a degradable polyamine and an optional trifunctional, tetrafunctional or polyfunctional polyhydric alcohol, polyether polyol, polyester polyol, polyamine, polymercaptan, or polyphenol, with a polyisocyanate.

In some embodiments, between each two cross-linking points, there is at least one cleavable moiety of structure

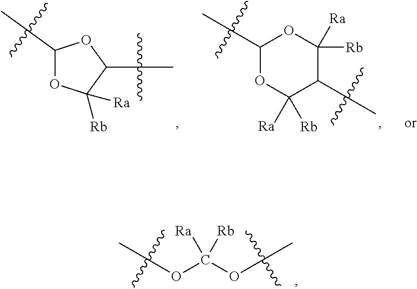

each of Ra and Rb is independently hydrogen, alkylene, cycloalkylene, heterocyclic alkylene, arylene and heteroarylene; or Ra and Rb, together with the carbon atom to which they are bonded, form a 3-7 membered ring optionally containing 1-4 heteroatoms each of which is independently S, O, or N.

In some other embodiments, the curing process is conducted at a temperature in the range from ambient temperature to 250° C. (e.g., 40-150° C., 40-100° C., or 60-120° C.).

In still some other embodiments, the curing process is conducted under a pressure in the range from ambient pressure to 10 atmospheric pressure (AMP), e.g., 1-5 AMP or 2-5 AMP.

In yet still some other embodiments, the curing process is conducted for a time period ranging from 10 second to 1 month (e.g., 30 seconds, 1 minute, 2 minutes, 5 minutes, 2 hours, 6 hours).

Still another aspect of the present invention provides reinforced composite materials each of which includes:

a degradable three-dimensional reticulated polyurethane matrix of claim 5;

a reinforcing material comprising carbon nanotubes, boron nitride nanotubes, carbon black, metal nanoparticles, metal oxide nanoparticles, organic nanoparticles, iron oxide, glass fiber, carbon fiber, natural fiber, chemical fiber, or fabrics made therefrom; and

an auxiliary material comprising an accelerator, a diluent, a plasticizer, a toughening agent, an adhesion promoter, a thickening agent, a coupling agent, a defoamer, a flatting agent, an ultraviolet absorber, an antioxidant, an optical brightener, a fluorescent agent, a gloss additive, a pigment, or a filler.

In some embodiments, the reinforced composite material is prepared by a process comprising wet lay-up, infusion, vacuum assisted infusion, RTM (resin transfer molding), HPRTM (high pressure resin transfer molding), filament winding, pultrusion, compression molding, or prepreg.

A recyclable composite material is typically degraded in the following manner: After a composite material is immersed in a hot recovery solution of acid and solvent, the polymer matrix would decompose first and then the reinforcing material can be separated and the polymer matrix can be recovered, e.g., after neutralizing the degradation solution with an alkaline solution to produce a precipitate. Under such conditions, the polymer matrix can be decomposed because it is an acid-sensitive cross-linked structure in which the bond cleavage of the acid-sensitive groups will occur. That will cause the crosslinked structure of the polymer matrix to be dissolved in a non-crosslinked polymer (e.g. a thermoplastic polymer) of an organic decomposition solvent. When the non-crosslinked polymer is fully dissolved, the reinforcing materials (e.g., carbon fibers) can be separated and removed from the degradation solution. The degradable polymer matrix yield can be recovered through the process of neutralization, sedimentation and solid-liquid separation. The reinforcing materials and recycled non-crosslinked polymers can therefore be separated, recovered and reused.

Yet still another aspect of the present invention provides methods for degrading and recycling a degradable three-dimensional reticulated polyurethane matrix described above or a reinforced composite material described above. Each method includes the steps of:

(1) immersing the degradable three-dimensional reticulated polyurethane matrix of claim 5 or the reinforced composite material of claim 10 in a degradation system comprising an acid and optionally a peroxide or peroxyacid with or without a solvent for 1˜600 hours to give a degradation mixture, wherein the degradation system is maintained at a temperature in the range of 15˜400° C. with agitating and the mass concentration of the acid in the degradation system is 0.01˜100%;

(2) recovering the reinforcing material, liberated from the reinforced composite material of claim 10 from the degradation mixture after the degradable three-dimensional reticulated polyurethane polymer matrix is fully degraded in step (1) by separating, washing and drying;

(3) neutralizing the degradation mixture from step (1) or (2) by using an alkali solution to above pH 6 while maintaining the temperature within the range of 0˜200° C. during neutralization, wherein the mass concentration of alkali solution is 0.01˜99%; and

(4) recovering the precipitates formed during neutralization in step (3) by separating, washing and drying.

In some embodiments, the acid includes hydrochloric acid, hydrobromic acid, hydrofluoric acid, acetic acid, trifluoroacetic acid, lactic acid, formic acid, propionic acid, citric acid, methanesulfonic acid, p-toluenesulfonic acid, nitric acid, sulfuric acid, sulfurous acid, phosphoric acid, perchloric acid, benzoic acid, salicylic acid, or phthalic acid; the peroxide or peroxyacid comprises hydrogen peroxide, performic acid, peroxyacetic acid, peroxypropionic acid, 2-butanone peroxide, bis(t-butyl)peroxide, perbenzoic acid, sodium peroxide, potassium peroxide, calcium peroxide, magnesium peroxide, or potassium persulfate; the solvent, if present, comprises methanol, ethanol, ethylene glycol, propanol, isopropanol, butanol, isobutanol, t-butanol, pentanol, hexanol, heptanol, octanol, nonanol, benzyl alcohol, phenethyl alcohol, p-hydroxymethyl benzene, m-hydroxymethyl benzene, o-hydroxy benzene, p-hydroxyethyl benzene, m-hydroxyethyl benzene, o-hydroxyethyl benzene, water, N,N-dimethylformamide, N,N-dimethylacetamide, N-methylpyrrolidone, dimethyl sulfoxide, tetrahydrofuran, methyl tetrahydrofuran, glycerol, or dioxane; the alkali comprises lithium hydroxide, sodium hydroxide, potassium hydroxide, calcium hydroxide, sodium carbonate, sodium bicarbonate, potassium carbonate, potassium bicarbonate, or ammonia; and the solvent of the alkali solution comprises methanol, ethanol, ethylene glycol, propanol, isopropanol, butanol, isobutanol, t-butanol, pentanol, hexanol, heptanol, octanol, nonanol, benzyl alcohol, phenethyl alcohol, p-hydroxymethyl benzene, m-hydroxymethyl benzene, o-hydroxy benzene, p-hydroxyethyl benzene, m-hydroxyethyl benzene, o-hydroxyethyl benzene, water, N,N-dimethylformamide, N,N-dimethylacetamide, N-methylpyrrolidone, dimethyl sulfoxide, tetrahydrofuran, methyl tetrahydrofuran, glycerol, dioxane, or combinations thereof.

In some other embodiments, in step (1), the degradation system is maintained at a temperature in the range of 80150° C., the polyurethane polymer matrix or the reinforced composite material is immersed in the heated degradation system for 1˜16 hours, and the mass concentration of the acid in the solvent is preferably 1˜99%; and in step (2), the temperature is within the range of 5˜50° C., the final pH value after neutralization is in the range of 7˜12, and the mass concentration of alkali solution is in the range of 5˜30%.

In some embodiments, within the scope of the present invention is a method for recycling a reinforced composite material, comprising the steps of: (1) under the heating and stirring conditions, immersing the reinforced composite material in a degradation system comprising an acid and a solvent and then heating the degradation system at a temperature in the range of 15400° C. for 1600 hours to give rise to a degradation mixture, wherein the mass concentration of acid in the degradation mixture is 0.1˜99%; (2) using an alkali solution of 0200° C. to adjust the pH value of the degradation mixture from step (1) to be greater than 6 to obtain a precipitate, wherein the mass concentration of the alkali in the alkali solution is 0.1˜99%; and (3) separate, wash and dry the precipitate obtained in step (2).

In some embodiments, the acid comprises hydrochloric acid, hydrobromic acid, hydrofluoric acid, acetic acid, trifluoroacetic acid, lactic acid, formic acid, propionic acid, citric acid, methanesulfonic acid, p-toluenesulfonic acid, nitric acid, sulfuric acid, sulfurous acid, phosphoric acid, perchloric acid, benzoic acid, salicylic acid, or phthalic acid; the solvent comprises at least one of methanol, ethanol, ethylene glycol, propanol, isopropanol, butanol, isobutanol, t-butanol, pentanol, hexanol, heptanol, octanol, nonanol, benzyl alcohol, phenethyl alcohol, p-hydroxymethyl benzene, m-hydroxymethyl benzene, o-hydroxy benzene, p-hydroxyethyl benzene, m-hydroxyethyl benzene, o-hydroxyethyl benzene, water, N,N-dimethylformamide, N,N-dimethylacetamide, N-methylpyrrolidone, dimethyl sulfoxide, tetrahydrofuran, methyl tetrahydrofuran, glycerol, or dioxane; the alkali comprises lithium hydroxide, sodium hydroxide, potassium hydroxide, calcium hydroxide, sodium carbonate, sodium bicarbonate, potassium carbonate, potassium bicarbonate, or ammonium hydroxide; and the alkali solvent comprises methanol, ethanol, ethylene glycol, propanol, isopropanol, butanol, isobutanol, t-butanol, pentanol, hexanol, heptanol, octanol, nonanol, benzyl alcohol, phenethyl alcohol, p-hydroxymethyl benzene, m-hydroxymethyl benzene, o-hydroxy benzene, p-hydroxyethyl benzene, m-hydroxyethyl benzene, o-hydroxyethyl benzene, water, N,N-dimethylformamide, N,N-dimethylacetamide, N-methylpyrrolidone, dimethyl sulfoxide, tetrahydrofuran, methyl tetrahydrofuran, glycerol, or dioxane.

In still some other embodiments, in step (1), the mass concentration of acid in the solvent is within the range of 0.520%, the temperature is within the range of 80˜200° C., and the reaction time is 2˜12 hours; and in step (2), the mass concentration of alkali solution is within the range of 5˜30%, the temperature is within the range of 5˜60° C.

Under the action of an acid, the cleavage or breaking of a particular chemical bond in the polyurethane results in the degradation of the polymer matrix. This degradation process may be performed under relatively mild, economical, and easily controlled reaction conditions. Therefore, the degradable polyurethanes of the present invention have significant environmental and economic advantages over conventional polyurethanes.

The present invention illustrates that during the degradation process of polyurethane composite material provided by the present invention, the cross-linked structure of polyurethane polymer matrix could be broken due to cleavage of specific chemical bonds, which leads to the degradation of the polymer matrix. The cross-linked structure could be transformed into a non-crosslinked polymer (e.g. a thermoplastic polymer) that could be dissolved in an organic solvent. When the non-crosslinked polymer is fully dissolved in an organic solvent, the reinforced materials can be removed from the solution thereby recovered for potential reuse. The degradation product of the polymer matrix can be recovered through the process of neutralization, sedimentation and solid-liquid separation. The reinforcing materials and recycled non-crosslinked polymers can also be separated, recovered and reused.

A proposed reaction mechanism for preparing a degradable polyurethane matrix of the present invention is shown below in Scheme 1.

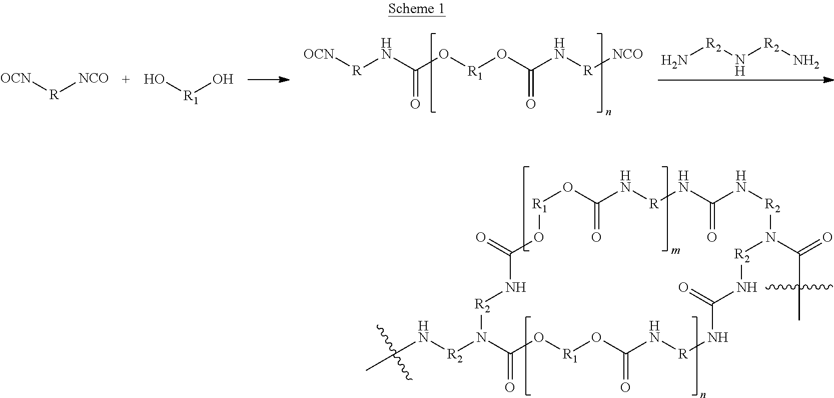

A proposed reaction mechanism for preparing a degradable polyurethane matrix of the present invention is shown below in Scheme 2.

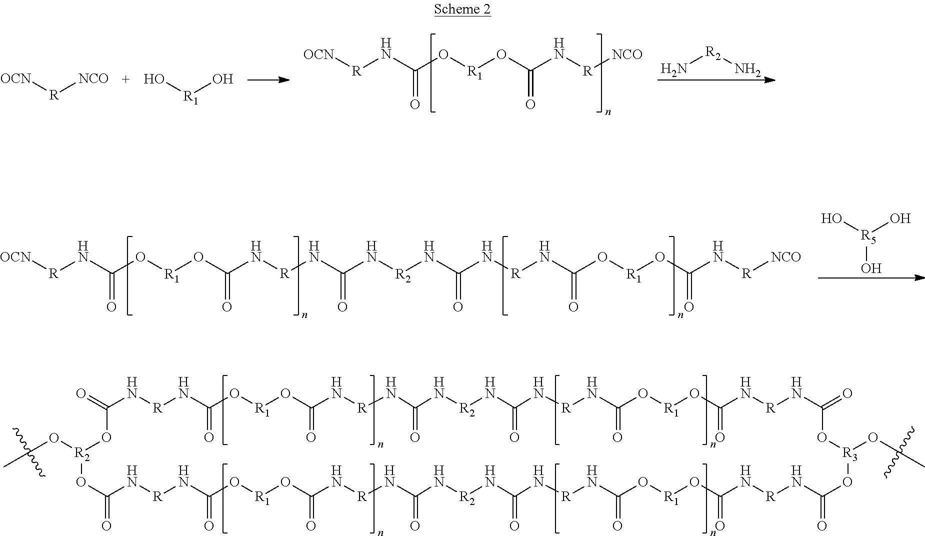

The degradable di-amines can include an acetal or ketal aliphatic amine (as described in, e.g., WO 2012/071896, WO 2013/007128, and CN 103249712A), an acetal or ketal aromatic amine or salt thereof (as described in, e.g., CN 103254406A, and WO 2014/169847 A), a cyclic acetal or ketal amine (as described in, e.g., CN 103242509A, and WO 2014/169846 A), an acetal or ketal hydrazide (as described in, e.g., CN 103193959A and WO 2014/169847 A), or hydrazone (as described in, e.g., CN 201310440092.0 and WO 2015/043462 A).

Due to their unique structure and excellent performance, polyurethane materials of polyfoam, elastomers, adhesives and others are widely used in construction, automotive, defense, aerospace and other fields. Currently, research of recyclable polyurethanes is mostly focused on linear polyurethanes. However, these linear polyurethanes have poor mechanical properties and cannot undergo complete degradation. Degradable cross-linked polyurethanes of the present invention unexpectedly have much better mechanical properties and more complete degradation capability than linear polymers with a similar structure. Thus, the degradable cross-linked polyurethane polymers of this invention can be widely used as polyfoam, elastomers, adhesives and others.

The degradable polyurethanes of this invention can combine with glass fibers, carbon fibers, natural fibers, synthetic fibers, or other fiber composite material to obtain the composite materials under the standard or common procedures of preparing composites materials. The composite materials can also be prepared by the combination of degradable polyurethane with non-fibrous materials such as carbon nanotubes, boron nitride nanotubes, carbon black, metal nanoparticles, metal oxide nanoparticles, organic nanoparticles, iron oxide, or other non-fibrous materials.

As used herein, the term “alkyl,” when used alone or as part of a larger moiety (e.g., as in “alkyl-hetero-alkyl”), refers to a saturated aliphatic hydrocarbon group. It can contain 1 to 12 (e.g., 1 to 8, 1 to 6, or 1 to 4) carbon atoms. As a moiety, it can be denoted as —CₙH₂ₙ₊₁. An alkyl group can be straight or branched. Examples of alkyl groups include, but are not limited to, methyl, ethyl, propyl, isopropyl, butyl, isobutyl, sec-butyl, tert-butyl, n-pentyl, n-heptyl, and 2-ethylhexyl. An alkyl group can be substituted (i.e., optionally substituted) with one or more substituents. When an alkyl is preceded by a carbon-number modifier, e.g., C₁₋₈, its means the alkyl group contains 1 to 8 carbon atoms.

As used herein, the term “alkylene,” when used alone or as part of a larger moiety (e.g., as in “alkylene-oxy-hetero-cyclic”), refers to a saturated aliphatic hydrocarbon group with two radical points for forming two covalent bonds with two other moieties. It can contain 1 to 12 (e.g., 1 to 8, 1 to 6, or 1 to 4) carbon atoms. As a moiety, it can be denoted as —CₙH₂ₙ—. Examples of an alkylene group include, but are not limited to, methylene (—CH₂—), ethylene (—CH₂CH₂—), and propylene (—CH₂CH₂CH₂—). When an alkylene is preceded by a carbon-number modifier, e.g., C₂₋₈, it means the alkylene group contains 2 to 8 carbon atoms.

As used herein, the term “alkynyl,” when used alone or as part of a larger moiety, refers to an aliphatic hydrocarbon group with at least one triple bond. It can contain 2 to 12 (e.g., 2 to 8, 2 to 6, or 2 to 4) carbon atoms. An alkynyl group can be straight or branched. Examples of an alkynyl group include, but are not limited to, propargyl and butynyl. When an alkynyl is preceded by a carbon-number modifier, e.g., C₂₋₈, it means the alkynyl group contains 2 to 8 carbon atoms.

As used herein, the term “alkenyl,” when used alone or as part of a larger moiety, refers to an aliphatic hydrocarbon group with at least one double bond. It can contain 2 to 12 (e.g., 2 to 8, 2 to 6, or 2 to 4) carbon atoms. An alkenyl group with one double bond can be denoted as —CₙH₂ₙ₋₁, or —CₙH₂ₙ₋₃ with two double bonds. Like an alkyl group, an alkenyl group can be straight or branched. Examples of an alkenyl group include, but are not limited to, allyl, isoprenyl, 2-butenyl, and 2-hexenyl. When an alkylene is preceded by a carbon-number modifier, e.g., C₃₋₈, it means the alkylene group contains 3 to 8 carbon atoms.

As used herein, the term “cycloalkyl,” when used alone or as part of a larger moiety (e.g., as in “oxy-cycloalkyl”), refers to a saturated carbocyclic mono-, bi-, or tri-cyclic (fused or bridged or spiral) ring system. It can contain 3 to 12 (e.g., 3 to 10, or 5 to 10) carbon atoms. Examples of cycloalkyl groups include, but are not limited to, cyclopropyl, cyclobutyl, cyclopentyl, cyclohexyl, cycloheptyl, adamantyl, norbornyl, cubyl, octahydro-indenyl, decahydro-naphthyl, bicyclo[3.2.1]octyl, bicyclo[2.2.2]octyl, bicyclo[3.3.1]nonyl, bicyclo[3.3.2.]decyl, bicyclo[2.2.2]octyl, adamantyl, azacycloalkyl, or ((aminocarbonyl)cycloalkyl)cycloalkyl. When a cycloalkyl is preceded by a carbon-number modifier, e.g., C₃₋₈, its means the alkyl group contains 3 to 8 carbon atoms.

As used herein, the term “cycloalkenyl,” when used alone or as part of a larger moiety (e.g., as in “oxy-cycloalkenyl”), refers to a non-aromatic carbocyclic ring system having one or more double bonds. It can contain 3 to 12 (e.g., 3 to 10, or 5 to 10) carbon atoms. Examples of cycloalkenyl groups include, but are not limited to, cyclopentenyl, 1,4-cyclohexa-di-enyl, cycloheptenyl, cyclooctenyl, hexahydro-indenyl, octahydro-naphthyl, cyclohexenyl, cyclopentenyl, bicyclo[2.2.2]octenyl, orbicyclo[3.3.1]nonenyl.

As used herein, the term “heterocycloalkyl,” when used alone or as part of a larger moiety (e.g., as in “cycloalkylene-oxy-cycloalkenyl”), refers to a 3- to 16-membered mono-, bi-, or tri-cyclic (fused or bridged or spiral)) saturated ring structure, in which one or more of the ring atoms is a heteroatom (e.g., N, O, S, or combinations thereof). In addition to the heteroatom(s), the heterocycloalkyl can contain 3 to 15 carbon atoms (e.g., 3 to 12 or 5 to 10). Examples of a heterocycloalkyl group include, but are not limited to, piperidyl, piperazyl, tetrahydropyranyl, tetrahydrofuryl, 1,4-dioxolanyl, 1,4-dithianyl, 1,3-dioxolanyl, oxazolidyl, isoxazolidyl, morpholinyl, thiomorpholyl, octahydrobenzofuryl, octahydrochromenyl, octahydrothiochromenyl, octahydroindolyl, octahydropyrindinyl, decahydroquinolinyl, octahydrobenzo[b]thiopheneyl, 2-oxa-bicyclo[2.2.2]octyl, I-aza-bicyclo[2.2.2]octyl, 3-aza-bicyclo[3.2.1]octyl, and 2,6-dioxa-tricyclo[3.3.1.03,7]nonyl. A monocyclic heterocycloalkyl group can be fused with a phenyl moiety such as tetrahydroisoquinoline. When a heterocycloalkyl is preceded by a carbon-number modifier, e.g., C₄₋₈, it means the heterocycloalkyl group contains 4 to 8 carbon atoms.

As used herein, the term “hetero,” when used alone or as part of a larger moiety (e.g., as in “heterocyclo,” “heterocycloalkyl,” “heterocycloalkylene” or “heteroaryl”), refers to a hetero atom or group that is —O—, —S—, or —NH—, if applicable.

As used herein, the term “aryl,” when used alone or as part of a larger moiety (e.g., as in “alkylenearyl”), refers to a monocyclic (e.g., phenyl), bicyclic (e.g., indenyl, naphthalenyl, or tetrahydronaphthyl), and tricyclic (e.g., fluorenyl, tetrahydrofluorenyl, tetrahydroanthracenyl, or anthracenyl) ring system in which the monocyclic ring system is aromatic (e.g., phenyl) or at least one of the rings in a bicyclic or tricyclic ring system is aromatic (e.g., phenyl). The bicyclic and tricyclic groups include, but are not limited to, benzo-fused 2- or 3-membered carbocyclic rings. For instance, a benzo-fused group includes phenyl fused with two or more C₄₋₈ carbocyclic moieties.

As used herein, the term “heteroaryl” refers to a monocyclic, bicyclic, or tricyclic ring system having 5 to 15 ring atoms wherein at least one of the ring atoms is a heteroatom (e.g., N, O, S, or combinations thereof) and when the monocyclic ring system is aromatic or at least one of the rings in the bicyclic or tricyclic ring systems is aromatic. It can contain 5 to 12 or 8 to 10 ring atoms. A heteroaryl group includes, but is not limited to, a benzo-fused ring system having 2 to 3 rings. For example, a benzo-fused group includes benzo fused with one or two 4- to 8-membered heterocycloalkyl moieties (e.g., indolizyl, indolyl, isoindolyl, 3H-indolyl, indolinyl, benzo[b]furyl, benzo[b]thiophenyl, quinolinyl, or isoquinolinyl). Some examples of heteroaryl are pyridyl, IH-indazolyl, furyl, pyrrolyl, thienyl, thiazolyl, oxazolyl, imidazolyl, tetrazolyl, benzofuryl, isoquinolinyl, benzithiazolyl, xanthenyl, thioxanthenyl, phenothiazinyl, dihydroindolyl, benzo[1,3]dioxolyl, benzo [b] furyl, benzo [b]thiophenyl, indazolyl, benzimidazolyl, benzthiazolyl, puryl, quinolinyl, quinazolinyl, phthalazyl, quinazolyl, quinoxalyl, isoquinolinyl, 4H-quinolizyl, benzo-1,2,5-thiadiazolyl, and 1,8-naphthyridyl.

As used herein, the suffix “-ene” is used to describe a bivalent group with two radical points for forming two covalent bonds with two other moieties. In other words, any of the terms as defined above can be modified with the suffix “-ene” to describe a bivalent version of that moiety. For example, a bivalent aryl ring structure is “arylene,” a bivalent benzene ring structure is “phenylene,” a bivalent heteroaryl ring structure is “heteroarylene,” a bivalent cycloalkyl ring structure is a “cycloalkylene,” a bivalent heterocycloalkyl ring structure is “heterocycloalkylene,” a bivalent cycloalkenyl ring structure is “cycloalkenylene,” a bivalent alkenyl chain is “alkenylene,” and a bivalent alkynyl chain is “alkynylene.”

As used herein, the term “optionally” (e.g., as in “optionally substituted with”) means that the moiety at issue is either substituted or not substituted, and that the substitution occurs only when it is chemically feasible. For instance, H cannot be substituted with a substituent and a covalent bond or —C(═O)— group cannot be substituted with a substituent.

As used herein, an “oxo” or “oxide” group refers to ═O.

As used herein, an “oxy” group refers to —O—.

As used herein, a “carbonyl” group refers to —C(O)— or —C(═O)—.

As used herein, the term “1,4-alkyl substituted piperazine” refers to

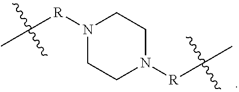

As used herein, the word “optionally” means that the event or subject following may or may not happen or be present.

For convenience and as commonly understood, the term “optionally substituted” only applies to the chemical entities that can be substituted with suitable substituents, not to those that cannot be substituted chemically.

As used herein, the term “or” can mean “or” or “and.”

### DETAILED DESCRIPTION OF THE INVENTION

The following examples are provided for illustration of the present invention only, and not intended to be limiting in any aspect.

### EXAMPLE 1

### Synthesis of Cross-Linker I

296 g aqueous ammonia and 32 g ammonium chloride were added into the reaction flask and stirred to dissolve, then 50 g bis (2-chloroethoxy) methane was added at room temperature. Then heated up to 80° C., the reaction was stirred for 6 hours, detecting the end of the reaction by TLC. After the reaction, most of solution was concentrated under reduced pressure, the residue was transferred to a reaction flask, adjusted pH with 30% sodium hydroxide solution to pH≥10 at less than 25° C., extracted the aqueous phase by 300 ml mixture of chloroform and ethanol (volume ratio 3: 1) for 3 times, the organic phases was combined and dried by anhydrous sodium sulfate, filtered, and the filter cake was washed with a small amount of solvent for 1 time. The filtrate was concentrated to dry to give 20 g cross-linker I, the value of total amine was 5.9 mmol/g.

### EXAMPLE 2

### Synthesis of Cross-Linker II

69.4 g ethanediamine was added into the reaction flask with stirring, then 10 g bis (2-chloroethoxy) methane was dropwise added at room temperature for 1 hour. Then heated up to 120° C., the reaction was stirred for 20 hours, detecting the end of the reaction by TLC. After the reaction, most of solution was concentrated under reduced pressure, the residue was transferred to a reaction flask, adjusted pH with 30% sodium hydroxide solution to pH≥10 at less than 25° C., extracted the aqueous phase by 90 ml dichloromethane for 3 times, the organic phases was combined and dried by anhydrous sodium sulfate, filtered, and the filter cake was washed with a small amount of solvent for 1 time. The filtrate was concentrated to dry to give 12 g cross-linker II, the value of total amine was 9.7 mmol/g.

### EXAMPLE 3

### Synthesis of Cross-Linker III

500 g aqueous ammonia and 1 g urotropin were added into the reaction flask and stirred to dissolve, then 50 g bis (2-chloroethoxy) methane was added at room temperature. Then heated up to 80° C., the reaction was stirred for 6 hours, detecting the end of the reaction by TLC. After the reaction, most of solution was concentrated under reduced pressure, the residue was transferred to a reaction flask, adjusted pH with 30% sodium hydroxide solution to pH≥10 at less than 25° C., extracted the aqueous phase by 300 ml mixture of chloroform and ethanol (volume ratio 3: 1) for 3 times, the organic phases was combined and dried by anhydrous sodium sulfate, filtered, and the filter cake was washed with a small amount of solvent for 1 time. The filtrate was concentrated to dry to give 14 g cross-linker III, the value of total amine was 5.2 mmol/g.

### EXAMPLE 4

### Preparation of the Curing Agent A

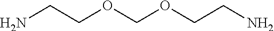

Curing agent A was synthesized according methods described in WO 2013007128.

### EXAMPLE 5

### Preparation of the Curing Agent B

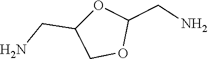

Curing agent B was synthesized according methods described in WO 2014169846.

### EXAMPLE 6

### Preparation of the Curing Agent C

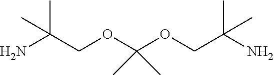

89 g 2-nitropropane, 30 g paraformaldehyde and 100 mL triethylamine were placed in a 250 mL round bottom flask and stirred at 45° C. for 0.5 h. The reaction mixture was filtered to obtain 60 g 2-methyl-2-nitropropan-1-ol.

11.9 g 2-methyl-2-nitropropan-1-ol, 5.7 g 2,2-dimethoxy propane, and 0.3 g p-toluene sulfonic acid and 500 mL of cyclohexane were mixed in a 1 L round bottom flask equipped with Dean-Stark apparatus to distill evolved methanol. After 6 h, the solution was cooled to room temperature, a moderate amount of sodium carbonate was added into the reaction bottle, then the reaction solution was concentrated at reduced pressure to give 5.7 g 2-methyl-1-((2-(2-methyl-2-nitropropoxy) propan-2-yl)oxy)-2-nitropropane.

1 g 2-methyl-1-((2-(2-methyl-2-nitropropoxy)propan-2-yl)oxy)-2-nitropropane, 0.1 g Raney nickel and 25 mL methanol were mixed in a 50 mL round bottom and reduced by hydrogen gas at 55° C. for 12 h. The reaction mixture was filtered and the filtrate was concentrated at reduced pressure to give 0.7 g curing agent C.

### EXAMPLE 7

### Preparation of the Curing Agent D

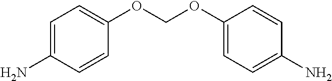 [SMILES: Nc1ccc(OCOc2ccc(N)cc2)cc1]

Curing agent D was synthesized according methods described in WO 2014169847.

### EXAMPLE 8

### Preparation of Degradable Polyurethane

Polyethylene glycol 1000, MDI and curing agent A were mixed at the mass ratio of 100/20/1. After quickly defoamed under vacuum with vigorous stirring, the mixture was cured at the room temperature, followed by postcured in an 80° C. oven for 2 hours to give a degradable polyurethane.

### EXAMPLE 9

### Preparation of Degradable Polyurethane

Polyethylene glycol 1000, MDI, curing agent C were mixed at the mass ratio of100/13/1. After quickly defoamed under vacuum with vigorous stirring, the mixture was cured at the room temperature, followed by postcured in an 80° C. oven for 2 hours to give a degradable polyurethane.

### EXAMPLE 10

### Preparation of Degradable Polyurethane

Polyethylene glycol 1000, MDI and curing agent D were mixed at the mass ratio of 100/20/1.5. After quickly defoamed under vacuum with vigorous stirring, the mixture was cured at room temperature, followed by postcured in an 80° C. oven for 2 hours to give a degradable polyurethane.

### EXAMPLE 11

### Preparation of Degradable Polyurethane

Polyethylene glycol 1000, Isocyanate TDI and curing agent A were mixed at the mass ratio of 100/20/10. After quickly defoamed under vacuum with vigorous stirring, the mixture was cured at room temperature, followed by postcured in an 80° C. oven for 2 hours to give a degradable polyurethane.

### EXAMPLE 12

### Degradation of Degradable Polyurethane

In a round-bottomed flask, a piece of the degradable polyurethane sample (1.0 g) from Example 8 was immerged in a mixture of 10 mL concentrated hydrochloric acid and 90 mL ethylene glycol. The degradation solution was stirred at 100° C. for 4 hours to give a clear solution which was neutralized with a 20% aqueous sodium hydroxide solution. The resultant suspension was filtered, and the collected solid was washed with water and dried, giving a mass recovery yield of 96.5%.

### EXAMPLE 13

### Degradation of Degradable Polyurethane

In a round-bottomed flask, a piece of the degradable polyurethane sample (1.0 g) from Example 9 was immerged in a mixture of 1 mL concentrated hydrochloric acid and 90 mL ethylene glycol. The degradation solution was stirred at 180° C. for 2 hours to give a clear solution which was neutralized with a 20% aqueous sodium hydroxide solution. The resultant suspension was filtered, and the collected solid was washed with water and dried, giving a mass recovery yield of 96%.

### EXAMPLE 14

### Degradation of Degradable Polyurethane

In a round-bottomed flask, a piece of the degradable polyurethane sample (1.0 g) from Example 10 was immerged in a mixture of 10 mL concentrated hydrochloric acid and 90 mL ethylene glycol. The degradation solution was stirred at 100° C. for 4 hours giving a clear solution which was neutralized with a 20% aqueous sodium hydroxide solution. The resultant suspension was filtered, and the collected solid was washed with water and dried, giving a mass recovery yield of 97%.

### EXAMPLE 15

### Degradation of Degradable Polyurethane

In a round-bottomed flask, a piece of degradable polyurethane sample (1.0 g) from Example 11 was immerged in a mixture of 1 mL concentrated hydrochloric acid and 90 mL ethylene glycol. The degradation solution was stirred at 180° C. for 2 hours giving a clear solution which was neutralized with a 20% aqueous sodium hydroxide solution. The resultant suspension was filtered, and the collected solid was washed with water and dried, giving a mass recovery yield of 98%.

### EXAMPLE 16

### Preparation of Recyclable Carbon Fiber Polyurethane Composite

Polyethylene glycol 1000, MDI and curing agent A were mixed at the mass ratio of 100/28.2/10. After quickly defoamed under vacuum with vigorous stirring, the mixture was evenly applied over three layers of 2x2 twill carbon fiber (3 K) fabric sheets. The resultant stack was then cured on a flat hot-pressing machine at 80° C. under a pressure of 10 atms for 2 hours, giving a recyclable carbon fiber polyurethane composite laminate.

### EXAMPLE 17

### Preparation of Recyclable Carbon Fiber Polyurethane Composite

Polyethylene glycol 1000, isocyanate TDI, curing agent A were mixed at the mass ratio of 100/20/10. After quickly defoamed under vacuum with vigorous stirring, the mixture was evenly applied over three layers of 2x2 twill carbon fiber (3 K) fabric sheets. The resultant stack was then cured on a flat hot-pressing machine at 80° C. under a pressure of 10 atms for 2 hours, giving a recyclable carbon fiber polyurethane composite laminate.

### EXAMPLE 18

### Degradation of Recyclable Carbon Fiber Polyurethane Composite Panel

In a round-bottomed flask, a piece of recyclable carbon fiber polyurethane composite sample (1.0 g) from Example 16 was immerged in a mixture of 10 mL concentrated hydrochloric acid and 90 mL ethylene glycol. After heated at 100° C. for 4 hours, the degradation solution was filtered to separate the carbon fibers, and the filtrate was neutralized with a 20% aqueous sodium hydroxide solution. The resultant suspension was filtered again, and the collected solid was washed with water and dried, giving a mass recovery yield of 96%.

### EXAMPLE 19

### Degradation of Recyclable Carbon Fiber Polyurethane Composite Panel

In a round-bottomed flask, a piece of recyclable carbon fiber polyurethane composite sample (1.0 g) from Example 17 was immerged in a mixture of 1 mL concentrated hydrochloric acid and 90 mL ethylene glycol. After heated at 180° C. for 2 hours, the degradation solution was filtered to separate the carbon fibers, and the filtrate was neutralized with a 20% aqueous sodium hydroxide solution. The resultant suspension was filtered again, and the collected solid was washed with water and dried, giving a mass recovery yield of 96%.

### EXAMPLE 20

### Preparation of the Curing Agent E

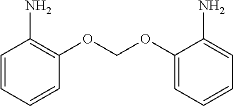 [SMILES: Nc1ccccc1OCOc1ccccc1N]

Curing agent E was synthesized according methods described in WO 2014169847.

### EXAMPLE 21

### Preparation of Degradable Polyurethane

20 g HKP-244 (polyester diol, mol. wt. 2000) was dehydrated for 1.5 hours at 50° C. under vacuum, 4 g MDI was added dropwise with stirring. After the addition, the mixture was held at 70° C. for 2 hours under vacuum to obtain the prepolymer. Into the prepolymer, 0.3 g curing agent D was added with stirring, vacuumed for 30 minutes at 70° C., and then cured at 130° C. for 6 hours to give polyurethane elastomer.

### EXAMPLE 22

### Preparation of Degradable Polyurethane

20 g HKP-244 (polyester diol, mol. wt. 2000) was dehydrated for 1.5 hours at 50° C. under vacuum, 4 g MDI and 0.3 g curing agent D were added with stirring, vacuumed for 30 minutes at 70° C., then cured at 130° C. for 6 hours to give polyurethane elastomer.

### EXAMPLE 23

### Preparation of Degradable Polyurethane

20 g HKP-244 (polyester diol, mol. wt. 2000) was dehydrated for 1.5 hours at 50° C. under vacuum, 4 g MDI was added dropwise with stirring. After the addition, the mixture was held at 70° C. for 2 hours under vacuum to obtain the prepolymer. Into the prepolymer, 0.3 g curing agent E was added with stirring, vacuumed for 30 minutes at 70° C., and then cured at 110° C. for 6 hours to give polyurethane elastomer.

### EXAMPLE 24

### Preparation of Degradable Polyurethane

20 g HKP-244 (polyester diol, mol. wt. 2000) was dehydrated for 1.5 hours at 50° C. under vacuum, 4 g MDI and 0.3 g curing agent E were added with stirring, vacuumed for 30 minutes at 70° C., then cured at 110° C. for 6 hours to give polyurethane elastomer 4.

### EXAMPLE 25

### Preparation of Degradable Polyurethane

20 g HKP-244 (polyester diol, mol. wt. 2000) was dehydrated for 1.5 hours at 50° C. under vacuum, 4 g MDI was added dropwise with stirring. After the addition, the mixture was held at 70° C. for 2 hours under vacuum to obtain the prepolymer. Into the prepolymer, 0.2 g curing agent A was added with stirring, vacuumed for 30 minutes at 70° C., then cured at 80° C. for 6 hours to give polyurethane elastomer 5.

### EXAMPLE 26

### Preparation of Degradable Polyurethane

20 g HKP-244 (polyester diol, mol. wt. 2000) was dehydrated for 1.5 hours at 50° C. under vacuum, 4 g MDI and 0.2 g curing agent A were added with stirring, vacuumed for 30 minutes at 70° C., then cured at 80° C. for 6 hours to give polyurethane elastomer 6.

### EXAMPLE 27

### Degradation of Degradable Polyurethane

95 g ethylene glycol, 5 g concentrated hydrochloric acid and 1 g polyurethane elastomer from example 21 (thickness is 2 mm, width is 2-3 mm) were mixed and stirred at 130˜138° C. until degraded completely to get light yellow solution. The time was 5 hours.

### EXAMPLE 28

### Degradation of Degradable Polyurethane

90 g ethylene glycol, 10 g concentrated hydrochloric acid and 1 g polyurethane elastomer from example 21 (thickness is 2 mm, width is 2-3 mm) were mixed and stirred at 130˜138° C. until degraded completely to get colorless solution. The time was 3 hours.

### EXAMPLE 29

### Degradation of Degradable Polyurethane

95 g ethylene glycol, 5 g concentrated hydrochloric acid and 1 g polyurethane elastomer from example 22 (thickness is 2 mm, width is 2-3 mm) were mixed and stirred at 130˜138° C. until degraded completely to get light yellow solution. The time was 3 hours.

### EXAMPLE 30

### Degradation of Degradable Polyurethane

90 g ethylene glycol, 10 g concentrated hydrochloric acid and 1 g polyurethane elastomer from example 22 (thickness is 2 mm, width is 2-3 mm) were mixed and stirred at 130˜138° C. until degraded completely to get colorless solution. The time was 3 hours.

### EXAMPLE 31

### Degradation of Degradable Polyurethane

95 g ethylene glycol, 5 g concentrated hydrochloric acid and 1 g polyurethane elastomer from example 23 (thickness is 2 mm, width is 2-3 mm) were mixed and stirred at 130˜138° C. until degraded completely to get light yellow solution. The time was 4.5 hours.

### EXAMPLE 32

### Degradation of Degradable Polyurethane

90 g ethylene glycol, 10 g concentrated hydrochloric acid and 1 g polyurethane elastomer from example 23 (thickness is 2 mm, width is 2-3 mm) were mixed and stirred at 130˜138° C. until degraded completely to get colorless solution. The time was 2.5 hours.

### EXAMPLE 33

### Degradation of Degradable Polyurethane

95 g ethylene glycol, 5 g concentrated hydrochloric acid and 1 g polyurethane elastomer from example 24 (thickness is 2 mm, width is 2-3 mm) were mixed and stirred at 130˜138° C. until degraded completely to get light yellow solution. The time was 3 hours.

### EXAMPLE 34

### Degradation of Degradable Polyurethane

90 g ethylene glycol, 10 g concentrated hydrochloric acid and 1 g polyurethane elastomer from example 24 (thickness is 2 mm, width is 2-3 mm) were mixed and stirred at 130˜138° C. until degraded completely to get colorless solution. The time was 3 hours.

### EXAMPLE 35

### Degradation of Degradable Polyurethane

95 g ethylene glycol, 5 g concentrated hydrochloric acid and 1 g polyurethane elastomer from example 25 (thickness is 2 mm, width is 2-3 mm) were mixed and stirred at 130˜138° C. until degraded completely to get light yellow solution. The time was 2 hours.

### EXAMPLE 36

### Degradation of Degradable Polyurethane

90 g ethylene glycol, 10 g concentrated hydrochloric acid and 1 g polyurethane elastomer from example 25 (thickness is 2 mm, width is 2-3 mm) were mixed and stirred at 130˜138° C. until degraded completely to get colorless solution. The time was 1 hours.

### EXAMPLE 37

### Degradation of Degradable Polyurethane

95 g ethylene glycol, 5 g concentrated hydrochloric acid and 1 g polyurethane elastomer from example 26 (thickness is 2 mm, width is 2-3 mm) were mixed and stirred at 130˜138° C. until degraded completely to get light yellow solution. The time was 1.5 hours.

### EXAMPLE 38

### Degradation of Degradable Polyurethane

90 g ethylene glycol, 10 g concentrated hydrochloric acid and 1 g polyurethane elastomer from example 26 (thickness is 2 mm, width is 2-3 mm) were mixed and stirred at 130˜138° C. until degraded completely to get colorless solution. The time was 1.5 hours.

### EXAMPLE 39

### Preparation of Degradable Polyurethane

20 g HKP-244 (polyester diol, mol. wt. 2000) was dehydrated for 1.5 hours at 50° C. under vacuum, 4 g MDI was added dropwise with stirring. After the addition, the mixture was held at 70° C. for 2 hours under vacuum to obtain the prepolymer. Into the prepolymer, 0.72 g cross-linker I from Example 1 was added with stirring, vacuumed for 30 minutes at 70° C., and then cured at 80° C. for 6 hours to give sample 1.

### EXAMPLE 40

### Preparation of Degradable Polyurethane

20 g HKP-244 (polyester diol, mol. wt. 2000) was dehydrated for 1.5 hours at 50° C. under vacuum, 4 g MDI and 0.72 cross-linker I from Example 1 were added with stirring, vacuumed for 30 minutes at 70° C., then cured at 80° C. for 6 hours to give sample 2.

### EXAMPLE 41

### Preparation of Degradable Polyurethane

20 g HKP-244 (polyester diol, mol. wt. 2000) was dehydrated for 1.5 hours at 50° C. under vacuum, 4 g MDI was added dropwise with stirring. After the addition, the mixture was held at 70° C. for 2 hours under vacuum to obtain the prepolymer. Into the prepolymer, 0.43 g cross-linker II from Example 2 was added with stirring, vacuumed for 30 minutes at 70° C., and then cured at 120° C. for 6 hours to give sample 3.

### EXAMPLE 42

### Preparation of Degradable Polyurethane

20 g HKP-244 (polyester diol, mol. wt. 2000) was dehydrated for 1.5 hours at 50° C. under vacuum, 4 g MDI and 0.43 cross-linker II from Example 2 were added with stirring, vacuumed for 30 minutes at 70° C., and then cured at 120° C. for 6 hours to give sample 4.

### EXAMPLE 43

### Preparation of Degradable Polyurethane

20 g HKP-244 (polyester diol, mol. wt. 2000) was dehydrated for 1.5 hours at 50° C. under vacuum, 4 g MDI was added dropwise with stirring. After the addition, the mixture was held at 70° C. for 2 hours under vacuum to obtain the prepolymer. Into the prepolymer, 0.8 g cross-linker III from Example 3 was added with stirring, vacuumed for 30 minutes at 70° C., and then cured at 120° C. for 6 hours to give sample 5.

### EXAMPLE 44

### Preparation of Degradable Polyurethane

20 g HKP-244 (polyester diol, mol. wt. 2000) was dehydrated for 1.5 hours at 50° C. under vacuum, 4 g MDI and 0.8 g cross-linker III from Example 3 were added with stirring, vacuumed for 30 minutes at 70° C., and then cured at 120° C. for 6 hours to give sample 6.

### EXAMPLE 45

### Degradation of Degradable Polyurethane

95 g ethylene glycol, 5 g concentrated hydrochloric acid and 1 g sample 1 from Example 39 (thickness is 2 mm, width is 2-3 mm) were mixed and stirred at 130˜138° C. until degraded completely to get light yellow solution. The time was 3 hours.

### EXAMPLE 46

### Degradation of Degradable Polyurethane

90 g ethylene glycol, 10 g concentrated hydrochloric acid and 1 g sample 1 from Example 39 (thickness is 2 mm, width is 2-3 mm) were mixed and stirred at 130˜138° C. until degraded completely to get colorless solution. The time was 3 hours.

### EXAMPLE 47

### Degradation of Degradable Polyurethane

95 g ethylene glycol, 5 g concentrated hydrochloric acid and 1 g sample 2 from Example 40 (thickness is 2 mm, width is 2-3 mm) were mixed and stirred at 130˜138° C. until degraded completely to get light yellow solution. The time was 3 hours.

### EXAMPLE 48

### Degradation of Degradable Polyurethane

90 g ethylene glycol, 10 g concentrated hydrochloric acid and 1 g sample 2 from Example 40 (thickness is 2 mm, width is 2-3 mm) were mixed and stirred at 130˜138° C. until degraded completely to get colorless solution. The time was 3 hours.

### EXAMPLE 49

### Degradation of Degradable Polyurethane

95 g ethylene glycol, 5 g concentrated hydrochloric acid and 1 g sample 3 from Example 41 (thickness is 2 mm, width is 2-3 mm) were mixed and stirred at 130˜138° C. until degraded completely to get light yellow solution. The time was 1 hours.

### EXAMPLE 50

### Degradation of Degradable Polyurethane

90 g ethylene glycol, 10 g concentrated hydrochloric acid and 1 g sample 3 from Example 41 (thickness is 2 mm, width is 2-3 mm) were mixed and stirred at 130˜138° C. until degraded completely to get colorless solution. The time was 1 hours.

### EXAMPLE 51

### Degradation of Degradable Polyurethane

95 g ethylene glycol, 5 g concentrated hydrochloric acid and 1 g sample 4 from Example 42 (thickness is 2 mm, width is 2-3 mm) were mixed and stirred at 130˜138° C. until degraded completely to get light yellow solution. The time was 1 hours.

### EXAMPLE 52

### Degradation of Degradable Polyurethane

90 g ethylene glycol, 10 g concentrated hydrochloric acid and 1 g sample 4 from Example 42 (thickness is 2 mm, width is 2-3 mm) were mixed and stirred at 130˜138° C. until degraded completely to get colorless solution. The time was 1 hours.

### EXAMPLE 53

### Degradation of Degradable Polyurethane

95 g ethylene glycol, 5 g concentrated hydrochloric acid and 1 g sample 5 from Example 43 (thickness is 2 mm, width is 2-3 mm) were mixed and stirred at 130˜138° C. until degraded completely to get light yellow solution. The time was 1.5 hours.

### EXAMPLE 54

### Degradation of Degradable Polyurethane

90 g ethylene glycol, 10 g concentrated hydrochloric acid and 1 g sample 5 from Example 43 (thickness is 2 mm, width is 2-3 mm) were mixed and stirred at 130˜138° C. until degraded completely to get colorless solution. The time was 1.5 hours.

### EXAMPLE 55

### Degradation of Degradable Polyurethane

95 g ethylene glycol, 5 g concentrated hydrochloric acid and 1 g sample 6 from Example 44 (thickness is 2 mm, width is 2-3 mm) were mixed and stirred at 130˜138° C. until degraded completely to get light yellow solution. The time was 1.5 hours.

### EXAMPLE 56

### Degradation of Degradable Polyurethane

90 g ethylene glycol, 10 g concentrated hydrochloric acid and 1 g sample 6 from Example 44 (thickness is 2 mm, width is 2-3 mm) were mixed and stirred at 130˜138° C. until degraded completely to get colorless solution. The time was 1.5 hours.

### EXAMPLE 57

### Degradation of Degradable Polyurethane

90 g ethylene glycol, 10 g concentrated hydrochloric acid and 1 g sample 1 from Example 39 (thickness is 2 mm, width is 2-3 mm) were mixed and stirred at 90˜95° C. until degraded completely to get colorless solution. The time was 20 hours.

### EXAMPLE 58

### Degradation of Degradable Polyurethane

90 g ethylene glycol, 10 g concentrated hydrochloric acid and 1 g sample 2 from Example 40 (thickness is 2 mm, width is 2-3 mm) were mixed and stirred at 90˜95° C. until degraded completely to get colorless solution. The time was 20 hours.

### EXAMPLE 59

### Degradation of Degradable Polyurethane

90 g ethylene glycol, 10 g concentrated hydrochloric acid and 1 g sample 3 from Example 41 (thickness is 2 mm, width is 2-3 mm) were mixed and stirred at 90˜95° C. until degraded completely to get colorless solution. The time was 16 hours.

### EXAMPLE 60

### Degradation of Degradable Polyurethane

90 g ethylene glycol, 10 g concentrated hydrochloric acid and 1 g sample 4 from Example 42 (thickness is 2 mm, width is 2-3 mm) were mixed and stirred at 90˜95° C. until degraded completely to get colorless solution. The time was 16 hours.

### EXAMPLE 61

### Degradation of Degradable Polyurethane

90 g ethylene glycol, 10 g concentrated hydrochloric acid and 1 g sample 5 from Example 43 (thickness is 2 mm, width is 2-3 mm) were mixed and stirred at 90˜95° C. until degraded completely to get colorless solution. The time was 18 hours.

### EXAMPLE 62

### Degradation of Degradable Polyurethane

90 g ethylene glycol, 10 g concentrated hydrochloric acid and 1 g sample 6 from Example 44 (thickness is 2 mm, width is 2-3 mm) were mixed and stirred at 90˜95° C. until degraded completely to get colorless solution. The time was 18 hours.

WO 2015/081610 A1 described degradable isocyanates and their reactions with diamine or polyamines, and diol or polyols to form one kind of recyclable polyurethane network. W02015/081610 A1 disclosed recyclable polyurethane formed by reaction of degradable isocyanates with diols or polyols, and diamines or polyamines, including degradable diamine curing agents described in WO 2012/071896, WO 2013/007128, WO 2014/169846, and WO 2014/169847. The degradable curing agent can include an acetal or ketal aliphatic amine (see, e.g., WO 2012/071896, WO 2013/007128, and CN 103249712A), an acetal or ketal aromatic amine or salt thereof (see, e.g., CN 103254406A, and WO 2014/169847 A), a cyclic acetal or ketal amine (see, e.g., CN 103242509A, and WO 2014/169846 A), an acetal or ketal hydrazide (see, e.g., CN 103193959A and WO 2014/169847 A), or hydrazone (see, e.g., CN103483554 B and WO 2015/043462 A). All references referred to herein are incorporated by reference in their entireties.

### Other Embodiments

The invention has been described above with the reference to specific examples and embodiments, not to be constructed as limiting the scope of this invention in any way. It is understood that various modifications and additions can be made to the specific examples and embodiments disclosed without departing from the spirit of the invention, and such modifications and additions are contemplated as being part of the present invention.

1. An isocyanate resin composition comprising:
an isocyanate compound containing two or more isocyanate functional groups; and
a chain extender comprising a degradable diamine and optionally a dihydric alcohol, a polyether diol, a polyester diol, a diamine, a dimercaptan, or a bisphenol; wherein the degradable diamine is of the structure of 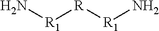
in which R is 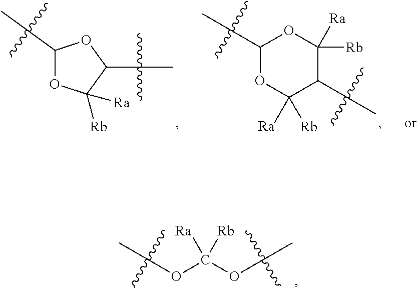
each of Ra and Rb is independently hydrogen, alkylene, cycloalkylene, heterocyclic alkylene, arylene and heteroarylene; or Ra and Rb, together with the carbon atom to which they are bonded, form a 3-7 membered ring optionally containing 1-5 heteroatoms each of which is independently S, O, or N; and each of R₁ and R₂ is independently alkylene, cycloalkylene, heterocyclic alkylene, arylene, heteroarylene, or aralkylene; and
a cross-linker comprising a degradable polyamine and optionally a trifunctional, tetrafunctional or polyfunctional polyhydric alcohol, polyether polyol, polyester polyol, polyamine, polymercaptan, or polyphenol; and the degradable polyamine is of Formula 1, 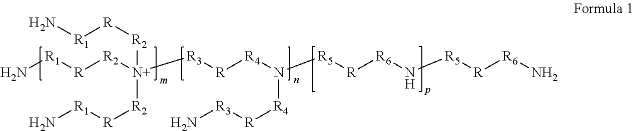
wherein each of m, n, and P, independently, is an integer of 0, 1, 2, 3, 4, 5, 6, 7, 8, 9, or 10; the sum of m, n and p is 3 or greater; R, R₁, and R₂ are the same as defined above for the degradable diamine in the chain extender; each of R₃, R₄, R₅ and R₆, independently, is alkylene, cycloalkylene, heterocyclic alkylene, arylene, heteroarylene, or aralkylene.

2. The isocyanate resin composition of claim 1, wherein the isocyanate compound comprises m-phenylene diisocyanate, 1,4-phenylene diisocyanate, 2,4-toluene diisocyanate, 2,6-toluene diisocyanate, 1,6-hexamethylene diisocyanate, isophorone diisocyanate, tetramethylxylene diisocyanate, tetramethylene diisocyanate, cyclohexane 1,4-diisocyanate, hexahydrotoluene diisocyanate, 1,5-naphthalene diisocyanate, 1-methoxyphenyl-2,4-diisocyanate, 2,2′-diphenylmethane diisocyanate, 2,4′-diphenylmethane diisocyanate, 4,4′-diphenylmethane diisocyanate, 1-methoxyphenyl-2,4-diisocyanate, 4,4′-biphenylene diisocyanate, 3,3′-dimethoxy-4,4′-diisocyanate, 3,3′-dimethyldiphenylmethane-4,4′-diisocyanate, 4,4′,4″-triphenylmethane triisocyanate, toluene 2,4,6-triisocyanate, 4,4′-dimethyldiphenylmethane 2,2′-5,5′-tetraisocyanate, polymethylene polyphenylene polyisocyanate, or an isomer thereof.

3. The isocyanate resin composition of claim 1, wherein the degradable diamine in the chain extender comprises:

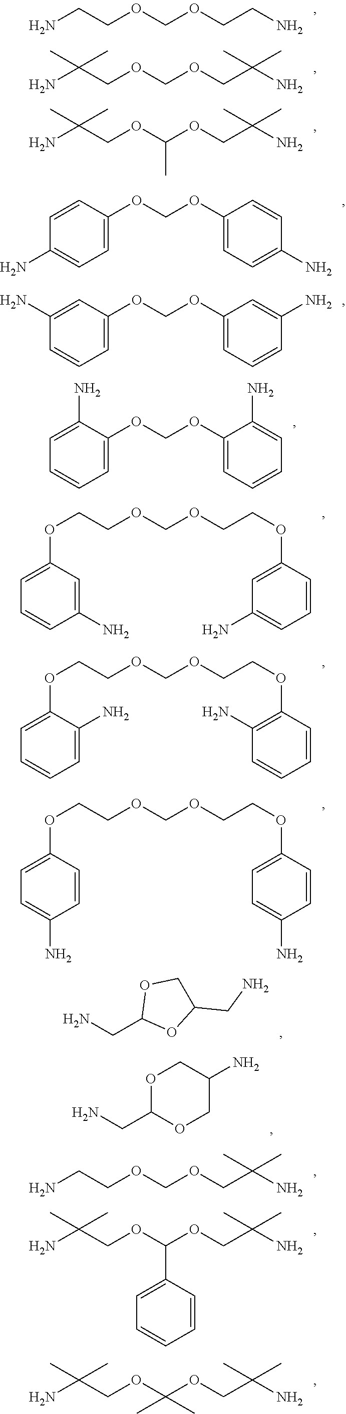

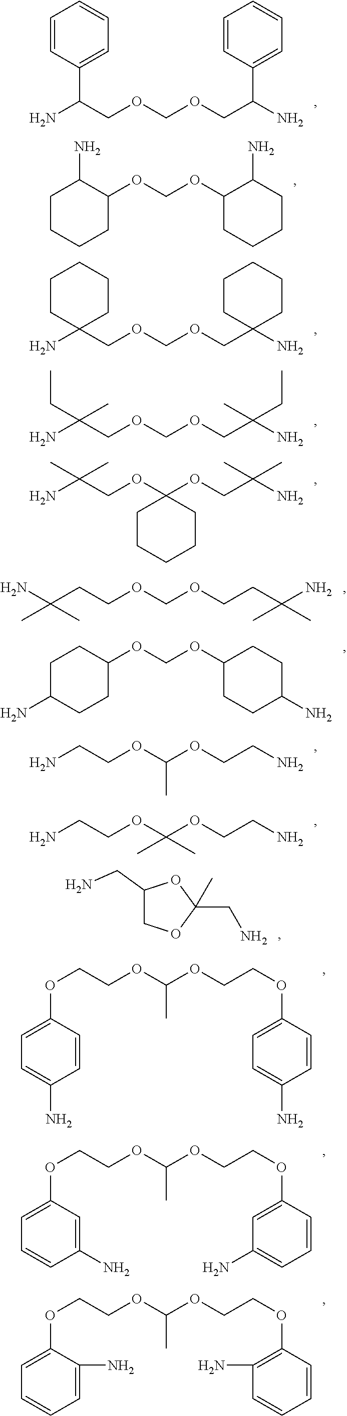

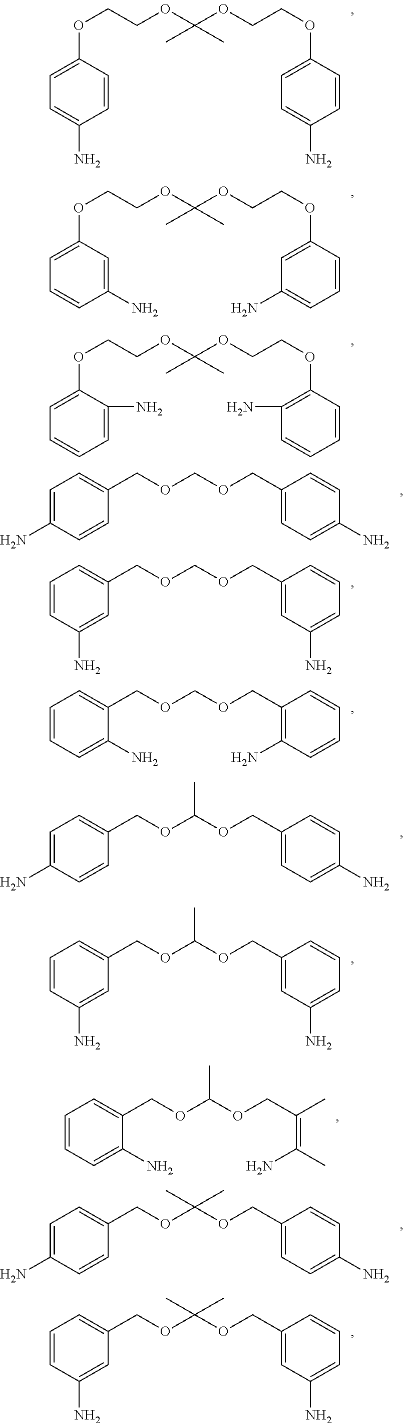

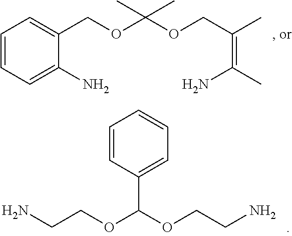 [SMILES: C/C(N)=C(\C)COC(C)(C)OCc1ccccc1N ; NCCOC(OCCN)c1ccccc1]

4. The isocyanate resin composition of claim 1, wherein the degradable polyamine in the cross-linker comprises:

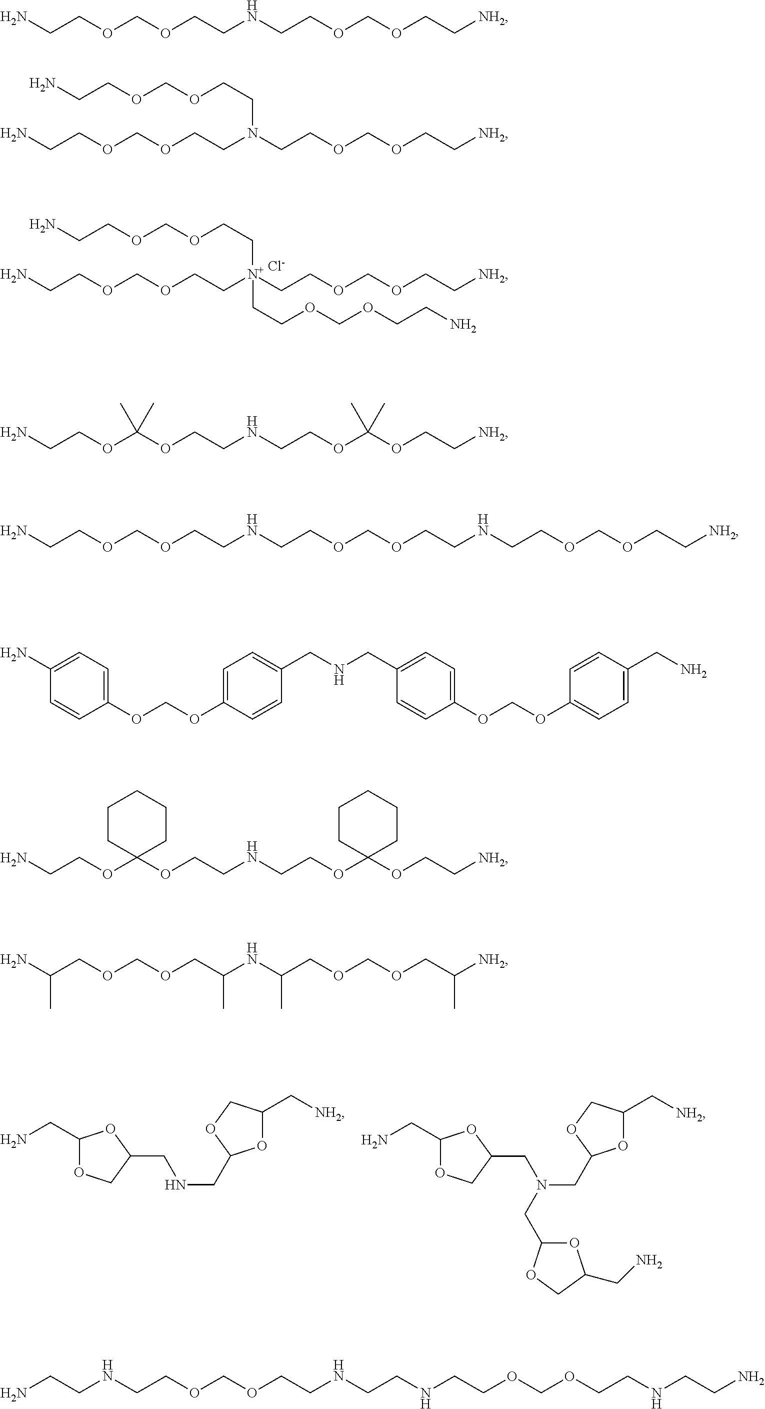

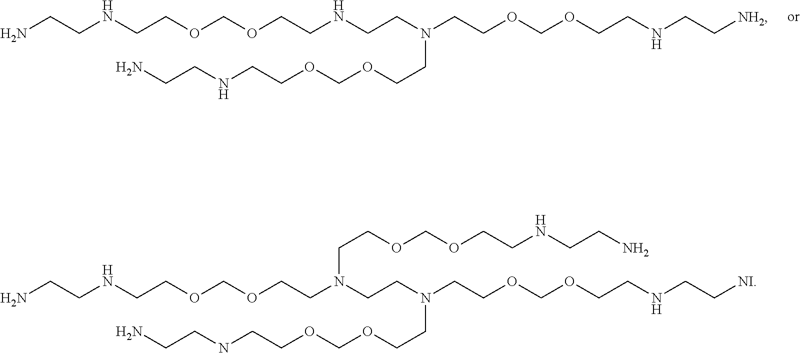

5. A degradable three-dimensional reticulated polyurethane matrix, wherein the polyurethane matrix is obtained by curing an isocyanate resin composition of claim 1 and possesses cross-linking points that are derived from reacting the cross-linker comprising a degradable polyamine and an optional trifunctional, tetrafunctional or polyfunctional polyhydric alcohol, polyether polyol, polyester polyol, polyamine, polymercaptan, or polyphenol, with a polyisocyanate.

6. The polyurethane matrix of claim 5, wherein, between each two cross-linking points, there is at least one cleavable moiety of structure 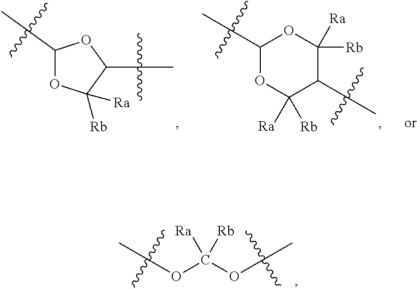
each of Ra and Rb is independently hydrogen, alkylene, cycloalkylene, heterocyclic alkylene, arylene and heteroarylene; or Ra and Rb, together with the carbon atom to which they are bonded, form a 3-7 membered ring optionally containing 1-4 heteroatoms each of which is independently S, O, or N.

7. The polyurethane matrix of claim 5, wherein the curing process is conducted at a temperature in the range from ambient temperature to 250° C.

8. The polyurethane matrix of claim 5, wherein the curing process is conducted under a pressure in the range from ambient pressure to 10 atmospheric pressure.

9. The polyurethane matrix of claim 5, wherein the curing process is conducted for a time period ranging from 10 second to 1 month.

10. A reinforced composite material comprising:
a degradable three-dimensional reticulated polyurethane matrix of claim 5;
a reinforcing material comprising carbon nanotubes, boron nitride nanotubes, carbon black, metal nanoparticles, metal oxide nanoparticles, organic nanoparticles, iron oxide, glass fiber, carbon fiber, natural fiber, chemical fiber, or fabrics made therefrom; and
an auxiliary material comprising an accelerator, a diluent, a plasticizer, a toughening agent, an adhesion promoter, a thickening agent, a coupling agent, a defoamer, a flatting agent, an ultraviolet absorber, an antioxidant, an optical brightener, a fluorescent agent, a gloss additive, a pigment, or a filler.

11. The reinforced composite material of claim 10, wherein the reinforced composite material is prepared by a process comprising wet lay-up, infusion, vacuum assisted infusion, RTM (resin transfer molding), HPRTM (high pressure resin transfer molding), filament winding, pultrusion, compression molding, or prepreg.

12. A method for degrading and recycling a degradable three-dimensional reticulated polyurethane matrix of claim 5, comprising the steps of:
(1) immersing the degradable three-dimensional reticulated polyurethane matrix of claim 5 or the reinforced composite material of claim 10 in a degradation system comprising an acid and optionally a peroxide or peroxyacid with or without a solvent for 1˜600 hours to give a degradation mixture, wherein the degradation system is maintained at a temperature in the range of 15˜400° C. with agitating and the mass concentration of the acid in the degradation system is 0.01˜100%;
(2) recovering the reinforcing material, liberated from the reinforced composite material of claim 10 from the degradation mixture after the degradable three-dimensional reticulated polyurethane polymer matrix is fully degraded in step (1) by separating, washing and drying;
(3) neutralizing the degradation mixture from step (1) or (2) by using an alkali solution to above pH 6 while maintaining the temperature within the range of 0˜200° C. during neutralization, wherein the mass concentration of alkali solution is 0.01˜99%; and
(4) recovering the precipitates formed during neutralization in step (3) by separating, washing and drying.

13. The method of claim 12, wherein the acid comprises hydrochloric acid, hydrobromic acid, hydrofluoric acid, acetic acid, trifluoroacetic acid, lactic acid, formic acid, propionic acid, citric acid, methanesulfonic acid, p-toluenesulfonic acid, nitric acid, sulfuric acid, sulfurous acid, phosphoric acid, perchloric acid, benzoic acid, salicylic acid, or phthalic acid; the peroxide or peroxyacid comprises hydrogen peroxide, performic acid, peroxyacetic acid, peroxypropionic acid, 2-butanone peroxide, bis(t-butyl)peroxide, perbenzoic acid, sodium peroxide, potassium peroxide, calcium peroxide, magnesium peroxide, or potassium persulfate; the solvent, if present, comprises methanol, ethanol, ethylene glycol, propanol, isopropanol, butanol, isobutanol, t-butanol, pentanol, hexanol, heptanol, octanol, nonanol, benzyl alcohol, phenethyl alcohol, p-hydroxymethyl benzene, m-hydroxymethyl benzene, o-hydroxy benzene, p-hydroxyethyl benzene, m-hydroxyethyl benzene, o-hydroxyethyl benzene, water, N,N-dimethylformamide, N,N-dimethylacetamide, N-methylpyrrolidone, dimethyl sulfoxide, tetrahydrofuran, methyl tetrahydrofuran, glycerol, or dioxane; the alkali comprises lithium hydroxide, sodium hydroxide, potassium hydroxide, calcium hydroxide, sodium carbonate, sodium bicarbonate, potassium carbonate, potassium bicarbonate, or ammonia; and the solvent of the alkali solution comprises methanol, ethanol, ethylene glycol, propanol, isopropanol, butanol, isobutanol, t-butanol, pentanol, hexanol, heptanol, octanol, nonanol, benzyl alcohol, phenethyl alcohol, p-hydroxymethyl benzene, m-hydroxymethyl benzene, o-hydroxy benzene, p-hydroxyethyl benzene, m-hydroxyethyl benzene, o-hydroxyethyl benzene, water, N,N-dimethylformamide, N,N-dimethylacetamide, N-methylpyrrolidone, dimethyl sulfoxide, tetrahydrofuran, methyl tetrahydrofuran, glycerol, dioxane, or combinations thereof.

14. The method of claim 12, wherein in step (1), the degradation system is maintained at a temperature in the range of 80˜150° C., the polyurethane polymer matrix or the reinforced composite material is immersed in the heated degradation system for 1˜16 hours, and the mass concentration of the acid in the solvent is preferably 1˜99%; and in step (2), the temperature is within the range of 5˜50° C., the final pH value after neutralization is in the range of 7˜12, and the mass concentration of alkali solution is in the range of 5˜30%.

15. A method for degrading and recycling a reinforced composite material of claim 10, comprising the steps of:
(1) immersing the degradable three-dimensional reticulated polyurethane matrix of claim 5 or the reinforced composite material of claim 10 in a degradation system comprising an acid and optionally a peroxide or peroxyacid with or without a solvent for 1˜600 hours to give a degradation mixture, wherein the degradation system is maintained at a temperature in the range of 15˜400° C. with agitating and the mass concentration of the acid in the degradation system is 0.01˜100%;
(2) recovering the reinforcing material, liberated from the reinforced composite material of claim 10 from the degradation mixture after the degradable three-dimensional reticulated polyurethane polymer matrix is fully degraded in step (1) by separating, washing and drying;
(3) neutralizing the degradation mixture from step (1) or (2) by using an alkali solution to above pH 6 while maintaining the temperature within the range of 0˜200° C. during neutralization, wherein the mass concentration of alkali solution is 0.01˜99%; and
(4) recovering the precipitates formed during neutralization in step (3) by separating, washing and drying.
